(19) United States
(12) Patent Application Publication
(10) Pub. No.: US 2013/0259414 A1
(43) Pub. Date: Oct. 3, 2013

(54) TANDEM BALL ROLLER BEARING AND ASSEMBLY METHOD

(71) Applicant: SCHAEFFLER TECHNOLOGIES AG & CO. KG, Herzogenaurach (DE)

(72) Inventor: Shakeel Shaikh, Windsor (CA)

(73) Assignee: SCHAEFFLER TECHNOLOGIES AG & CO. KG, Herzogenaurach (DE)

(21) Appl. No.: 13/786,510

(22) Filed: Mar. 6, 2013

Related U.S. Application Data
(60) Provisional application No. 61/617,855, filed on Mar. 30, 2012.

(51) Int. Cl. F16C 19/18; F16C 43/06

(52) U.S. Cl. CPC F16C 19/181; F16C 43/065
USPC 384/453; 29/898.041

(57) ABSTRACT

An angular contact bearing is provided having an outer and inner bearing rings, and a plurality of ball rollers arranged between the bearing rings in two rows having a same reference circular diameter. The ball rollers in each row are held by a respective bearing cage. The ball rollers all have a same or different diameter and each of the ball rollers has two respective lateral faces arranged parallel to one another which are flattened symmetrically from a spherical basic shape and run with running faces in respective groove-shaped raceways defined in an inner face of the outer bearing ring and in an outer face of the inner bearing ring. The raceways have pressure angle axes pitched at a pressure angle with respect to a bearing radial axis. Adjacent ones of the ball rollers of the two rows are spaced apart to exclude mutual frictional contact. An assembly method is also provided.

### FIELD OF INVENTION

The invention relates to angular contact rolling-element bearings, and is particularly related to tandem ball roller bearings which are provided as a replacement for tapered roller bearings or angular contact ball bearings in a tandem arrangement previously utilized for the Transmission, differential & power train applications.

### BACKGROUND

It is generally known to the person skilled in the art of rolling-element bearing technology that the support of shafts or hubs with axial and radial moment loading is usually carried out using angular contact rolling-element bearings which, due to high loading, are in most cases in the form of two oppositely arranged and axially preloaded tapered roller bearings. In cases where large axial forces arise, these tapered roller bearings are configured with a large pressure angle to ensure a strong axial support of the shaft.

In tapered roller bearings there is a sliding friction between the end face of the tapered rollers and the guide face of the bearing edge that is brought about due to their preload. This results in high friction due to metal to metal contact on the tapered rollers and the bearing edge. DE 198 39 481 A1 discloses a double row angular contact ball bearings in a tandem arrangement that can be loaded on one side and which are disposed in an O-arrangement relative to one another as a replacement for the know tapered roller bearing arrangements. This is noted as providing a substantially smaller frictional moment because the sliding friction is no longer present between the bearing balls and the raceway shoulders, so that the high friction and the temperature of the bearing are reduced and its efficiency is improved.

However, replacement of tapered roller bearings by double row angular contact ball bearings in tandem arrangement has proved disadvantageous in practice, since these angular contact ball bearings in tandem arrangement require increased axial installation space, in comparison to tapered roller bearings, due to the adjacently arranged raceways for the bearing balls and the large diameter of the bearing balls needed to achieve the required load capacity. Moreover, if such an angular contact ball bearing in tandem arrangement is to have a higher load capacity than a tapered roller bearing, costly changes to the bearing seats are necessary, disadvantageously increasing the production costs of the component concerned. Furthermore, such double row angular contact ball bearings in tandem arrangement give rise to increased manufacturing and material outlay when producing the bearings, as compared to tapered roller bearings, so that their production costs are likewise increased.

DE 10 2005 014 556 provides a rolling-element bearing consisting in a known fashion of an inner and an outer bearing ring, with the rolling bodies arranged between the bearing rings being configured as ball rollers with two respective lateral faces arranged parallel to one another and flattened symmetrically from a spherical basic shape, instead of bearing balls. The use of ball rollers as rolling bodies is intended to distinguish such an angular contact rolling-element bearing from multi-row angular contact ball bearings primarily by a minimized axial and radial installation space, and by an equal or increased load capacity with comparable manufacturing costs.

US2011/0033149 proposes that the DE 10 2005 014 556 ball roller bearing can be arranged in a tandem arrangement, but that this would be problematic in practice, and further addresses the perceived issues by providing that the respective adjacent ball rollers of the two rows have a distance from one another which excludes mutual frictional contact through enlargement of the distance between the pressure angle axes of their raceways and through guidance of the two rows of the ball rollers in two separate bearing cages, and at least the raceway, arranged on the inner bearing ring, of the ball rollers of the row with the larger reference circle is configured on one side with an axial extension which utilizes this distance.

However, even this arrangement suffers from requiring different sized ball rollers, with the smaller diameter row having ball rollers of a smaller diameter & less number of rolling elements due to smaller reference circular diameter, which results in a lower bearing load capacity as well as necessitates numerous additional parts due to the different size ball rollers utilized. It would be desirable to provide an angular bearing with increased load capacity for the same envelope size, as well as longer life and higher reliability due to lower stresses, and lower costs due to simplified assembly and a reduced number of different parts required for inventory

### SUMMARY

Briefly stated, the present invention provides an angular contact bearing having an outer bearing ring, an inner bearing ring, and a plurality of ball rollers arranged between the bearing rings, one beside the other, in two rows having a same reference circular diameter. The ball rollers in each of the rows are held at uniform distances from each other in a circumferential direction by a respective bearing cage. The ball rollers in each of the rows have a same diameter and each of the ball rollers has two respective lateral faces arranged parallel to one another which are flattened symmetrically from a spherical basic shape and run with running faces in two respective groove-shaped raceways defined in an inner face of the outer bearing ring and in an outer face of the inner bearing ring. The raceways have pressure angle axes pitched at a pressure angle with respect to a bearing radial axis. Adjacent ones of the ball rollers of the two rows have a distance from one another which excludes mutual frictional contact.

This arrangement provides advantages over the prior known design in that the prior tandem ball roller bearing designs included a first row of ball rollers with a larger diameter reference circle and a second row of ball rollers with a smaller diameter reference circle, with the second row of ball rollers having individual ball rollers with the same or smaller size. By using ball rollers of the same diameter located in two rows having a same reference circle diameter, the present invention provides increased load carrying capacity, longer bearing life, higher reliability, lower contact stresses as well as lower frictional torque which results in better fuel economy. Further, this arrangement allows the use of a single cage design which is common to both rows. This allows cost reductions based on the use of the same ball rollers and the same cage for both rows in the tandem ball bearing arrangement. However the possibility exists to design with different size ball rollers & cage design This is accomplished in the same envelope size as the prior known bearings or a reduced envelope due to either the bearing outside diameter or the bearing inside diameter being reduced since the two rows have a same reference circle diameter. Thus, a tandem ball bearing of higher stiffness and longer life can be provided for the same envelope size.

The invention also provides a method of assembling an angular contact bearing having an outer bearing ring, an inner bearing ring, and a plurality of ball rollers arranged between the bearing rings, as discussed above. Here, the method includes assembling the ball rollers in the bearing cage for a first one of the rows of the ball rollers inside a first one of the raceways in the outer bearing ring. The ball rollers and bearing cage for a second one of the rows of ball rollers are assembled in a second one of the raceways in the inner bearing ring. The outer bearing ring and inner bearing ring sub-assemblies are then slid axially together with a second one of the raceways in the outer bearing ring engaging the second row of ball rollers located in the second one of the raceways in the inner bearing ring, and a first one of the raceways in the inner bearing ring engaging the first row of ball rollers located in the first raceway and the outer bearing ring.

Preferably, in each of the bearing ring sub-assemblies, the ball rollers in cages are assembled in the raceways which are formed to axially hold the respective ball rollers in both axial directions.

In another aspect of the invention, an angular contact bearing is provided having an outer bearing ring, an inner bearing ring, and a plurality of ball rollers arranged between the bearing rings, one beside the other, in two rows having a same reference circular diameter. The ball rollers in each of the rows are held at uniform distances from each other in a circumferential direction by a respective bearing cage. The ball rollers in the first row have a different diameter from the ball rollers of the second row and each of the ball rollers has two respective lateral faces arranged parallel to one another which are flattened symmetrically from a spherical basic shape and run with running faces in two respective groove-shaped raceways defined in an inner face of the outer bearing ring and in an outer face of the inner bearing ring. The raceways have pressure angle axes pitched at a pressure angle with respect to a bearing radial axis. Adjacent ones of the ball rollers of the two rows have a distance from one another which excludes mutual frictional contact.

Other aspects and advantages of the invention are described below and in the claims and have not been repeated here.

### BRIEF DESCRIPTION OF THE DRAWINGS

The foregoing Summary and the following detailed description will be better understood when read in conjunction with the appended drawings, which illustrate a preferred embodiment of the invention. In the drawings:

FIG. 1 is an elevational view of a tandem ball roller bearing according to the invention;

FIG. 2 is a cross-sectional view taken along line 2-2 in FIG. 1;

FIG. 3a is a cross-sectional view of the outer bearing ring sub-assembly;

FIG. 3b is a cross-sectional view through the inner bearing ring sub-assembly;

FIG. 4 is a cross-sectional view showing the method of assembling the inner and outer bearing ring sub-assemblies in order to form the tandem ball roller bearing according to the invention; and

FIG. 5 is a cross-sectional view of a tandem ball roller bearing in accordance with a second embodiment of the invention.

### DETAILED DESCRIPTION OF THE PREFERRED EMBODIMENTS

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

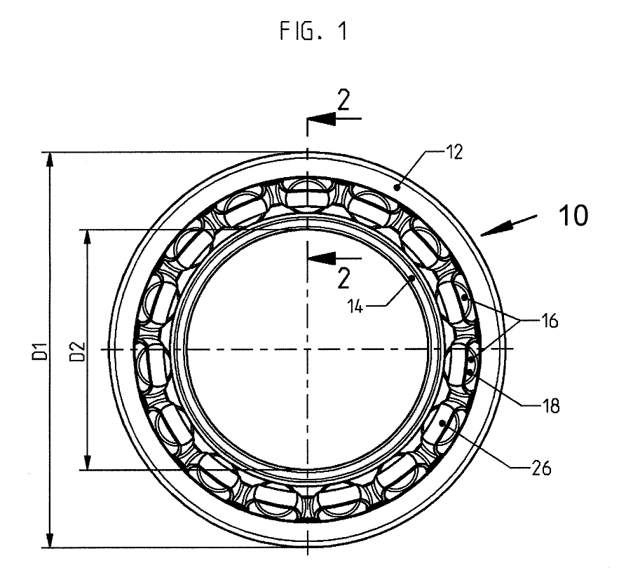

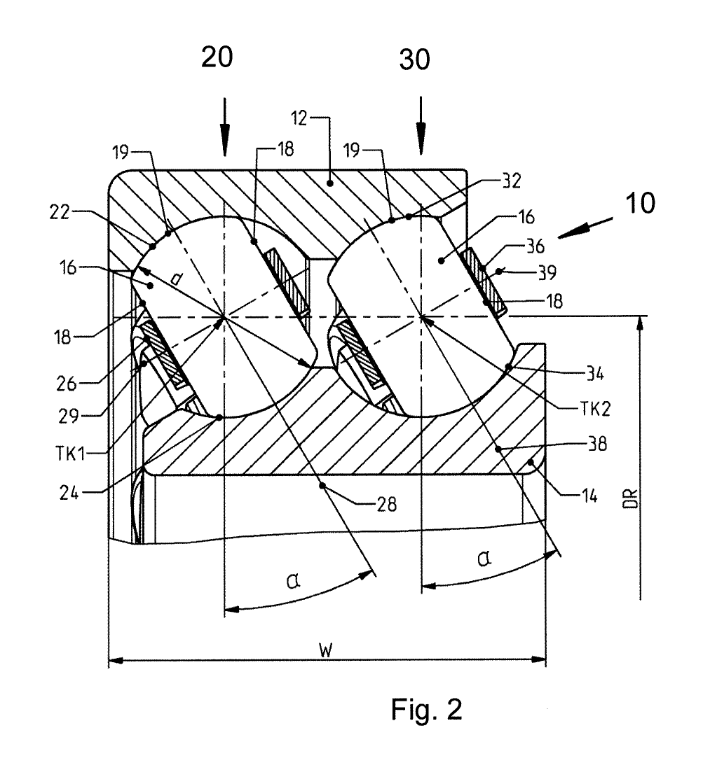

Referring to FIGS. 1 and 2, a tandem ball roller bearing 10 in accordance with the present invention is shown. The tandem ball roller bearing 10 includes an outer bearing ring 12 and an inner bearing ring 14. A plurality of ball rollers 16 are arranged between the outer and inner bearing rings 12, 14. The ball rollers 16 are arranged in a first row 20 and a second row 30, shown in FIG. 2, which are parallel to each other and have a same reference circle diameter Dᵣ for each of the reference circles, indicated at Tₖ₁ and Tₖ₂ in FIG. 2.

The ball rollers 16 in each of the rows 20, 30 have a same diameter d and each of the ball rollers 16 has two respective lateral faces 18 that are arranged parallel to one another which are flattened symmetrically from a spherical base shape. The ball rollers 16 also include running faces 19 formed by the remainder of the spherical shape which run in two respective groove-shaped raceways 22, 24 and 32, 34 defined in an inner face of the outer bearing ring 12 and in an outer face of the inner bearing ring 14, respectively. Each of the raceways 22, 24; 32, 34 have a respective pressure angle axis 28, 38 that is pitched at a pressure angle α with respect to a bearing radial axis, indicated along the bearing rows 20, 30 in FIG. 2. In the embodiment shown, α=30°. However, the pressure angle α can be varied based on the particular application and is typically in the range of 20° to 40°.

The ball rollers 16 in each of the rows 20, 30 are held at uniform distances from one another in a circumferential direction by a respective bearing cage 26, 36. The bearing cages 26, 36, preferably have the same shape and include windows in which each of the ball rollers 16 is located. Since the bearing cages 26, 36 have the same size and configuration, this results in fewer parts and reduced costs for tooling to form the bearing cages 26, 36. Preferably, the bearing cages 26, 36 are formed of a polymeric material.

Referring to FIG. 1, the bearing 10 has an envelope defined by an outside diameter D1 and an inside diameter D2, as well as a width w shown in FIG. 2. The prior known designs of tandem ball bearings utilizing a larger reference circle diameter for a first row of bearing balls than for the second row of bearing balls, as well as a larger diameter of the bearing balls in the first row having an outer diameter D1 of about 9.5 cm, an inner diameter D2 of about 4.1 cm and a width w of about 3.6 cm had a load carrying capacity that was about 30% lower for the same envelope. This calculation was done using the same hardened steel strength capacities for the bearing balls and the races and results from the present invention's use of an equal number of larger diameter balls in each of the rows of ball rollers in the tandem bearing design in which both rows have the same reference circle diameter Dᵣ. Thus, while keeping the same bearing envelope size as a traditional tandem ball bearing, a larger load carrying capacity was achieved. Depending on the size of the bearing required, generally increased load carrying capacities of up to about 30% are achievable according to the invention.

The increases in load carrying capacity can be made while keeping the rolling element size, width, and outer diameter of the bearing the same as a traditional bearing, but increasing the pitch diameter of the smaller row and reducing the inner ring cross-section in order to increase the inner diameter of the bearing. It would also be possible to keep the rolling element size and outside diameter of the bearing the same while increasing the bore diameter and reduce the bearing width. The use of different rolling element sizes will either reduce the bearing bore or width by increasing the pitch diameter of the small row to the same as the large row. Further, if only the same load bearing capacity is desired, then the overall size of the bearing can be reduced.

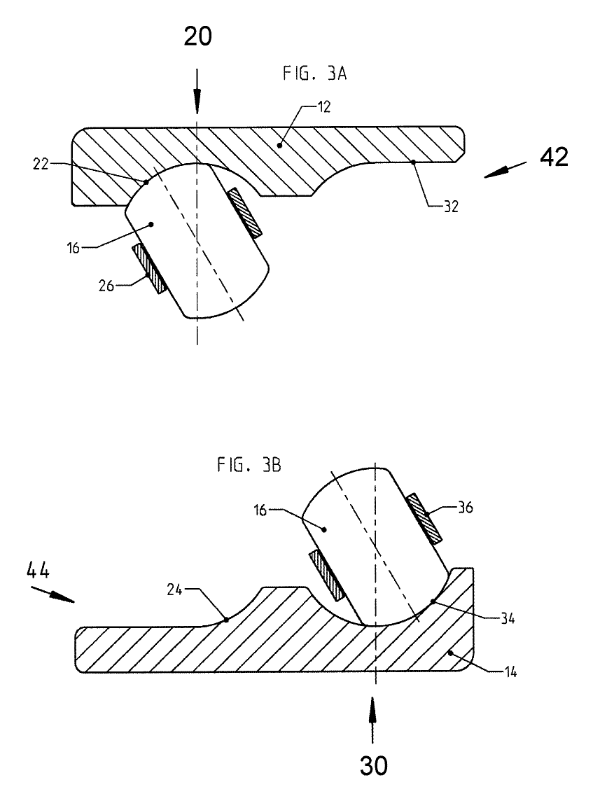

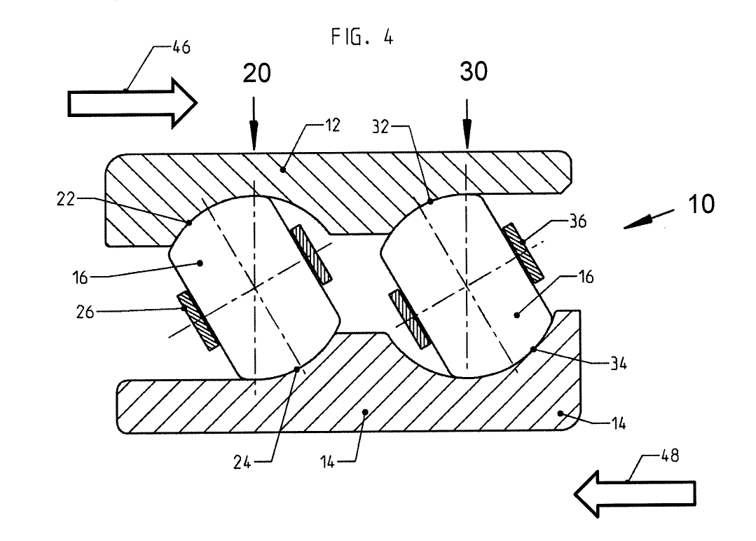

Referring now to FIGS. 3a, 3b and 4, a method of assembling the angular contact bearing 10 according to the invention is shown. As shown in FIG. 3a, the ball rollers 16 and the bearing cage 26 for the first row 20 are assembled inside a first one of the raceways 22 in the outer bearing ring 12 forming an outer bearing ring subassembly 42. In FIG. 3b, the ball rollers 16 and the bearing cage 36 for the second row 30 are assembled in a second one of the raceways 34 in the inner bearing ring 14 forming an inner bearing ring subassembly 44. In order to assemble the bearing 10, the inner and outer bearing ring subassemblies 42, 44 are slid axially together as shown in FIG. 4, with the movement being represented by arrows 46 and 48, such that the second one of the raceways 32 in the outer bearing ring 12 engages the second row 30 of ball rollers 16 located in the second one of the raceways 34 in the inner bearing ring 14 while the first one of the raceways 24 in the inner bearing ring 14 engages the first row 20 of ball rollers 16 located in the first raceway 22 of the outer bearing ring 12. Here, the first raceway 22 in the outer bearing ring 12 and the second raceway 34 in the inner bearing ring 14 are each formed to axially hold the respective ball roller 16 in both axial directions by providing what is known as a “moon circle race”. This axially holds the ball rollers 16 located within the respective cage 26, 36, in position from shifting axially. This assembly concept can also be used for other types of tandem ball bearings having multiple rows with different pitch diameters.

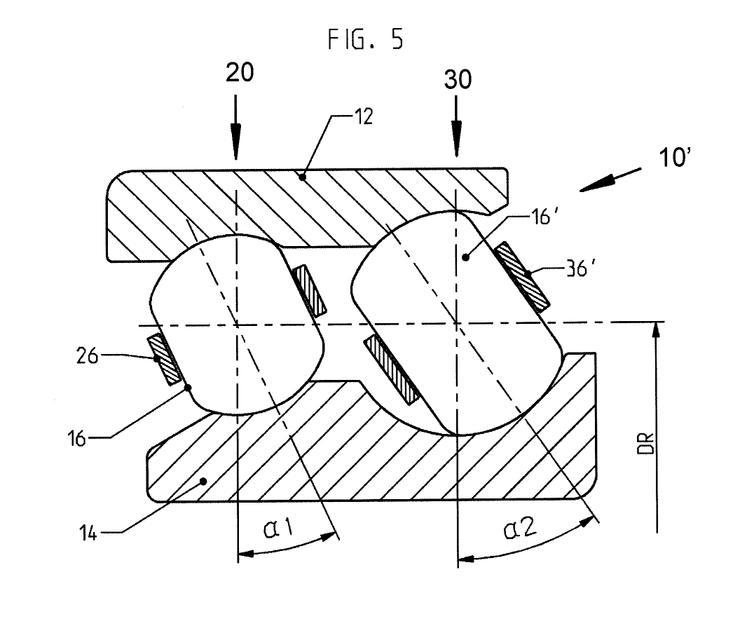

Referring to FIG. 5, a second embodiment of a tandem ball roller bearing 10′ is shown. The tandem ball roller bearing 10′ has the same basic construction as the bearing 10, except that the ball rollers 16 in the first row 20 are a different size than the ball rollers 16′ of the second row 30′, even though they are on same reference circle diameter Dᵣ. This allows for different pressure angles α1 and α2, although they could be the same. The cage 36′ is also adapted to the different size of the ball rollers 16′ in the second row 30′.

The tandem ball roller bearing 10, 10′ according to the invention can be used to replace traditional tandem ball bearings and taper roller bearings in various applications, such as a the axle, transmission, and/or other automotive or industrial applications.

While the invention has been described in detail based on a preferred embodiment, those skilled in the art will recognize that other changes can be made to the tandem ball roller bearing according to the invention as well as the assembly method that would fall within the scope of the invention. Accordingly, the scope of the invention is defined by the claims which follow below rather than the preferred embodiment.

What is claimed is:

1. An angular contact bearing, comprising: an outer bearing ring; an inner bearing ring; and a plurality of ball rollers arranged between the bearing rings, one beside the other in two rows having a same reference circle diameter, the ball rollers in each of the rows being held at uniform distances from one another in a circumferential direction by a respective bearing cage, each of the ball rollers has two respective lateral faces arranged parallel to one another which are flattened symmetrically from a spherical basic shape and run with running faces in two respective groove-shaped raceways defined in an inner face of the outer bearing ring and in an outer face of the inner bearing ring, the raceways having pressure angle axes pitched at a pressure angle with respect to a bearing radial axis, and adjacent ones of the ball rollers of the two rows have a distance from one another which excludes mutual frictional contact.

2. The angular contact bearing as claimed in claim 1, wherein the ball rollers in each of the rows have a same diameter.

3. The angular contact bearing as claimed in claim 1, wherein the two bearing cages of the ball roller bearing are plastic window cages.

4. The angular contact bearing as claimed in claim 1, wherein the two bearing cages have the same size and configuration.

5. The angular contact bearing as claimed in claim 4, wherein a load carrying capacity of each of the rows is equal.

6. A method of assembling an angular contact bearing having an outer bearing ring, an inner bearing ring, and a plurality of ball rollers arranged between the bearing rings, one beside the other in two rows having a same reference circle diameter, the ball rollers in each of the rows being held at uniform distances from one another in a circumferential direction by a respective bearing cage, each of the ball rollers has two respective lateral faces arranged parallel to one another which are flattened symmetrically from a spherical basic shape and run with running faces in two respective groove-shaped raceways defined in an inner face of the outer bearing ring and in an outer face of the inner bearing ring, the method comprising:
assembling the ball rollers and the bearing cage for a first one of the rows of ball rollers inside a first one of the raceways in the outer bearing ring forming an outer bearing ring subassembly;
assembling the ball rollers and the bearing cage for a second one of the rows of ball rollers in a second one of the raceways in the inner bearing ring forming an inner bearing ring subassembly; and
sliding the inner and outer bearing ring subassemblies axially together with a second one of the raceways in the outer bearing ring engaging the second row of ball rollers located in the second one of the raceways in the inner bearing ring, and a first one of the raceways in the inner bearing ring engaging the first row of ball rollers located in the first raceway in the outer bearing ring.

7. The method of claim 6, wherein the ball rollers in each of the rows have a same diameter.

8. The method of claim 6, wherein the first raceway in the outer bearing ring and the second raceway in the inner bearing ring are each formed to axially hold the respective ball rollers in both axial directions.
